(19) United States
(12) Patent Application Publication
(10) Pub. No.: US 2008/0031555 A1
(43) Pub. Date: Feb. 7, 2008

(54) Pouch-type packaging

(75) Inventor: Peter Roberts, Penrith (GB)

Correspondence Address: FISHER, CHRISTEN & SABOL, 1725 K STREET, N.W., SUITE 1108, WASHINGTON, DC, 20006, US

(73) Assignee: Alcan Technology & Management Ltd.

(21) Appl. No.: 11/260,194

(22) Filed: Oct. 28, 2005

(30) Foreign Application Priority Data
Nov. 11, 2004 (EP) 04026755.1

(51) Int. Cl. B65D 65/26; B31B 1/62

(52) U.S. Cl. 383/210; 493/267

(57) ABSTRACT

A pouch (10) of a flexible film (12, 14) with at least one sealing layer is such that the film (12, 14) is sealed onto itself or onto another film along a sealing seam (16) and delimits a space (18) for the contents. Part (20) of the sealing seam (16) is peelable apart. A suitable flexible film for manufacturing the pouch (10) is a multilayered co-extruded film which is joined via a second layer of a metallocene-catalyzed polyethylene to at least one further layer of homopolymer or copolymer polypropylene or polyethylene.

This application has priority benefit of European Patent Application No. 04026755.1, filed on Nov. 11, 2004.

The invention relates to a pouch of flexible film-type material with at least one sealing seam, whereby the film is sealed onto itself or another film along a sealing seam and delimits a space for the contents. The invention relates also to a process and a flexible film for manufacturing the pouch.

Pouches made from flexible film-type material are used widely today for packaging fluid and pourable contents of all kinds. Known forms of pouch-type packaging are e.g. flat, self-standing and tube-shaped pouches of different sizes for use in the home and in industry. Common to all pouches is the formation of a tightly sealed space for the contents which is formed by sealing flexible film-type material onto itself or onto another film-type material thus making a permanent seam. Normally, a pre-made pouch which is open at one place is produced at the start. After the contents have been put into the pouch, the pouch is sealed tightly by means of another seam.

To remove the contents from the pouch, such a pouch is e.g. torn open across the sealing seam or cut open using scissors at a place designated for that purpose. Often the pouch also exhibits an opening place in the form of a notch in the sealing seam.

The object of the invention is to create a pouch of the kind mentioned at the start which, on the one hand can be torn open in an easy manner, and on the other hand enables an opening for pouring to be formed without requiring excessive force and without mechanical aid.

That objective is achieved by way of the invention in that part of the sealing seam is can be peeled back.

In order to form an opening for pouring, the peelable part of the sealing seam preferably runs over a corner of the pouch.

Usefully at least one aid to tearing, in particular a notch, is provided in the sealing seam.

A preferred version of a pouch is a self-standing pouch with a base and a wall rising from the base, whereby the end of the pouch remote from the base forms at least one corner on the pouch and the peelable part of the sealing seam runs across the said corner. At least one aid to tearing, in particular a notch, may be provided in the sealing seam below the corner of the pouch.

A process for manufacturing a pouch made from a flexible film-type material with at least one sealing seam, in which the film is sealed onto itself thus forming a sealing seam that seals the pouch is such that, in order to form a peelable join between the films that are sealed onto each other, the said sealing seam is sealed in one region at a first temperature T₁, and in order to form a very high peel strength and considered a permanent join between the films that are sealed onto each other, sealed at a second temperature T₂ which is higher than the first temperature T₁.

The first temperature T₁ lies preferably in a range of 95 to 115° C. and the second temperature T₂ in a range >130° C. The breadth of the temperature frame for manufacturing a sealing seam with good peeling properties is about 20° C. Within this temperature frame the peeling force required to separate the sealing seam increases with increasing temperature.

In general the first temperature T₁ required to produce a peelable sealing seam lies approx. 15 to 30° C. lower than the second temperature T₂ required to pro-duce a very high peel strength or permanent, inseparable seam.

Setting the desired peeling force or the degree of inseparability of the seam is achieved by appropriate alteration of the temperature in the sealing station.

A suitable flexible film-type material for manufacturing a pouch according to the invention with the desired peeling properties in the sealing seam comprises at least three layers and is produced via multilayer blown film co-extrusion using the following sequence of layers:

A: sealing layer made of an ionomer-based elastomer polymer

B: metallocene-catalysed polyethylene

C: homopolymer or co-polymer polyethylene or polypropylene

The temperature range mentioned above applies in particular for the multilayer co-extrusion film according to the invention with the sequence of layers A-B-C C₁-C₂, C₃, . . . Cₙ)

The thickness of the film, depending on the application, normally lies approximately in the range of 30 to 150 μm. The thickness of the film is however not limited to this range. The number of C-layers of homopolmer or co-polymer polyethylene or polypropylene may vary, depending on the desired thickness of film.

The temperature range mentioned above applies in particular for the multilayer co-extrusion film according to the invention with the sequence of layers A-B-C (or C₁-C₂, C₃, . . . Cₙ).

Pouches of all shapes and sizes can be produced using the multilayer-co-extrusion films according to the invention. The principle advantage of the multilayer co-extrusion film compared with known packaging films made up of at least two films according to the state of the art, is that the dual function of peelable and inseparable sealing can by way of the invention be achieved by one single film-type laminate or one single film.

A further advantage of the multilayer co-extrusion film is apparent on tearing open the pouch. If the tearing notch is positioned such that the tear initiated from the notch lies in the running direction of the extruded film then, on tearing the pouch open further, the tear continues to run linearly in this direction. This property is taken into account in the manufacture of the pouch in that the intended line of tearing with the related notch is laid parallel to the running direction of the film.

Further advantages, features and details of the invention are revealed in the following description of preferred examples and with the aid of the drawing which shows schematically in

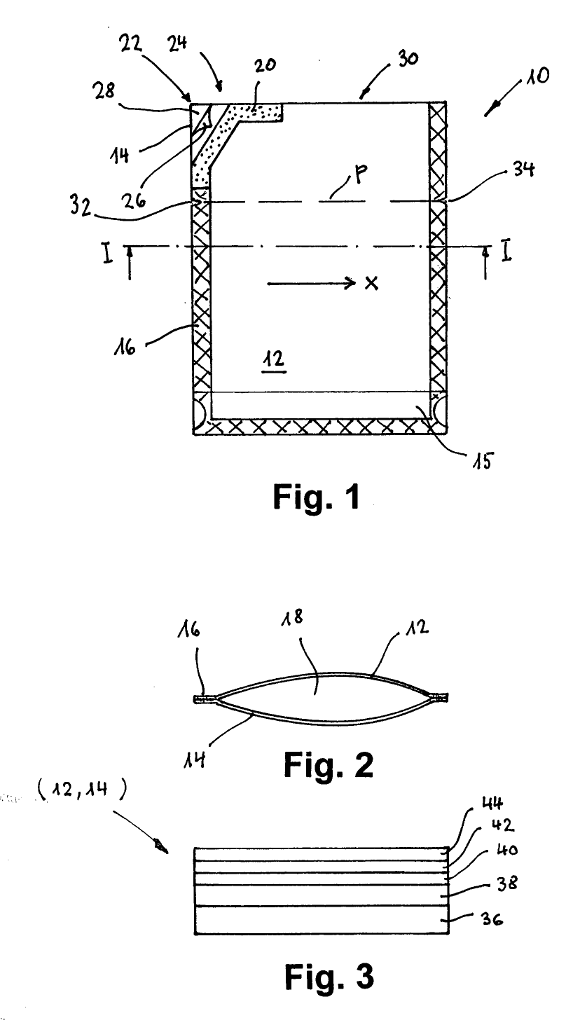

FIG. 1 a side view of a partly closed pouch;

FIG. 2 a cut through the pouch shown in FIG. 1 along line I-I;

FIG. 3 cross-section through a flexible film.

A pouch 10 shown in FIGS. 1 and 2 comprises two approximately rectangular-shaped wall parts 12, 14 made of flexible film-type material. Both wall parts 12, 12, 14 are joined very strongly or inseparably via a common sealing seam 16 and delimit a space 18 for the contents. Indicated in a base region of the pouch 10 is a base part of the same film-type material which is sealed between the wall parts 12, 14. On filling the pouch 10 the base part 15 becomes a part for standing the pouch on i.e. the pouch 10 is a so-called self-standing pouch.

A peelable part 20 of the sealing seam 16 runs across a corner 22 of the pouch remote from the base 15 and is a component of the easy-to-open closure 24. Tearing flaps 26, 28 situated in the region of the corner 22 and consisting of wall parts 12, 14 that are not sealed together in this corner region, serve as an aid to opening this closure.

In the edge region the pouch exhibits an opening 30. The opening 30 is delimited by the edge of the wall parts 12, 14 that are not yet sealed onto each other in this region. After filling the pouch 10 with its contents, both wall parts 12, 14 are sealed onto each other in the region of the opening, thus closing off the pouch.

Two facing notches 32, 34 are provided in the sealing seam 16 below the peelable region 20. The imaginary joining line p between the two notches 32, 34 lies parallel to the running direction x of the film out of which the wall parts 12, 14 are made.

The pouch may be opened two ways:
By pulling on the upper end of the pouch transverse to the sealing seam 16 with the notches 32, 34 the wall parts 12, 14 of the pouch 10 tear apart at one of the notches 32, 34. On pulling further, the tear progresses through both wall parts 12, 14 linearly and parallel to the running direction x of the film—forming a larger opening across the pouch 10 right up to the opposite edge of the pouch.

The different sealing strengths which lead to a very strongly joined or inseparable seam 16 and a peelable part 20 of the seam 16 is achieved by different sealing temperatures.

A particularly suitable film-type material for manufacturing the pouch 10 features—as shown in FIG. 3—a sealing layer 36 of an ionomer-based elastomer polymer. Bonded onto the sealing layer 36 is a layer 38 of a metallocene-catalysed polyethylene within a density range 0.927 to 0.956 g/cm³. Further layers 40, 42, 44 are, by way of choice, of homopolymer or co-polymer polyethylene or polypropylene.

1: A pouch of a flexible film (12, 14) with at least one sealing layer, the film (12, 14) is sealed along a sealing seam (16) onto itself or onto another film and delimits a space (18) for the contents, a part (20) of the sealing seam (16) can be peeled apart.

2: The pouch according to claim 1, wherein the peelable part (20) of the sealing seam (16) runs across a corner (22) of the pouch.

3: The pouch according to claim 2, wherein at least one aid to tearing (32, 34) is provided in the sealing seam (16).

4: The pouch according to claim 1, wherein the pouch is a self-standing pouch with a base part and wall rising from the base part, the end of the pouch remote from the base part forms at least one corner (22) and the peelable part (20) of the sealing seam (16) runs across the corner (22) of the pouch.

5: The pouch according to claim 4, wherein at least one aid to tearing (32, 34) is provided in the sealing seam (16) below the corner (22) of the pouch.

6: A process for manufacturing a pouch out of a flexible film (12, 14) having at least one sealing seam, sealing the film (12, 14) onto itself forming a sealing seam (16) thus forming a pouch (10), in order to form a peelable join between the films (12, 14) that are sealed onto each other, a part (20) of the sealing seam (16) is sealed at a first temperature T₁ and, in order to form a very strong or permanent join between the films (12, 14), the sealing seam (16) is sealed at a second temperature T₂ which is higher than the first temperature T₁.

7: The process according to claim 6, wherein the first sealing temperature T₁ lies in a range of 95 to 115° C. and the second temperature T₂ lies in a range greater than 130° C.

8: The process according to claim 7, wherein the first temperature T₁ lies 15 to 30° C. lower than the second temperature T₂.

9: A flexible film with a sealing layer (36) for manufacturing a pouch according to claim 5, wherein the film is a multilayer co-extruded film and the sealing layer (36) is of a ionomer-based elastomer polymer which is joined via a second layer (38) of a metallocene-catalyzed polyethylene to at least one other layer (40, 42) of homopolymer or co polymer copolymer polypropylene or polyethylene.

10: The flexible film according to claim 9, wherein the second layer (38) is of a metallocene-catalyzed linear polyethylene in the density range of 0.927 to 0.956 g/cm³.

11: The pouch according to claim 3, wherein the at least one aid to tearing (32, 34) is a notch.

12: The pouch according to claim 11, wherein there are two of the at least one aid to tearing (32, 34) and each thereof is a notch.

13: The pouch according to claim 5, wherein the at least one aid to tearing (32, 34) is a notch.

14: The pouch according to claim 13, wherein there are two of the at least one aid to tearing (32, 34) and each thereof is a notch.

15: The pouch according to claim 1, wherein at least one aid to tearing (32, 34) is provided in the sealing seam (16).

16: The pouch according to claim 15, wherein the at least one aid to tearing (32, 34) is a notch.

17: The pouch according to claim 16, wherein there are two of the at least one aid to tearing (32, 34) and each thereof is a notch.

18: A flexible film with a sealing layer (36) for manufacturing a pouch according to claim 1, wherein the film is a multilayer co-extruded film and the sealing layer (36) is a of a ionomer-based elastomer polymer which is joined via a second layer (38) of a metallocene-catalyzed polyethylene to at least one other layer (40, 42) of homopolymer or copolymer polypropylene or polyethylene.

19: The flexible film according to claim 9, wherein the second layer (38) is of a metallocene-catalyzed linear polyethylene in the density range 0.927 to 0.956 g/cm³.

20: The pouch according to claim 1, wherein a base region of the pouch is a base part (15) that is sealed between the film (12,14) along the sealing seam (16), the base part (15) is of the same film-type material of films (12, 14), and, upon filling of the pouch, the base part (15) becomes a part for standing the pouch on.
